(19) United States
(12) Patent Application Publication
(10) Pub. No.: US 2020/0359107 A1
(43) Pub. Date: Nov. 12, 2020

(54) DISPLAY DEVICE AND CONTROL METHOD THEREFOR

(71) Applicant: SAMSUNG ELECTRONICS CO., LTD., Suwon-si, Gyeonggi-do (KR)

(72) Inventors: Daewung KIM, Suwon-si (KR); Youngah LEE, Suwon-si (KR)

(73) Assignee: SAMSUNG ELECTRONICS CO., LTD., Suwon-si, Gyeonggi-do (KR)

(21) Appl. No.: 16/762,019

(22) PCT Filed: Nov. 22, 2018
(86) PCT No.: PCT/KR2018/014399

§ 371 Date: May 6, 2020

(30) Foreign Application Priority Data
Nov. 24, 2017 (KR) 10-2017-0158598

(51) Int. Cl. H04N 21/81; H04N 21/488; H04N 21/431; H04N 21/485

(52) U.S. Cl. CPC H04N 21/8126; H04N 21/488; H04N 21/4854; H04N 21/4858; H04N 21/4312

(57) ABSTRACT

A display apparatus includes: a receiver configured to communicate with a server; a display comprising a screen on which an image is displayable; and a processor configured to identify property values about two or more properties with respect to a plurality of content items based on information received from the server, control the display to display the content items to be arranged at positions corresponding to the property values along different directions on the screen based on the properties, and rearranges the content items based on change in the property value as updated with information received from the server. Thus, the display apparatus allows a user to be intuitively aware of a comparative relationship among the plurality of content items according to the properties.

### TECHNICAL FIELD

The disclosure relates to a display apparatus that displays images based on various pieces of content on a screen and a control method thereof, and more particularly to a display apparatus that displays a plurality of pieces of content classified in units of content items like news.

### BACKGROUND ART

A display apparatus collectively refers to an apparatus that displays a content image on a screen of its own display panel by applying an image processing process to a signal or data of content, and there is a television (TV) as an example of the display apparatus in general households. With development of technology, a trend toward expansion in the kinds and properties of content displayable by the display apparatus has emerged. In particular, the TV has typically been connected to the Internet, an intranet, or the like network to expand its functions. For example, the content displayable by the display apparatus includes a broadcast program transmitted by a broadcasting station, video-on-demand content streamed by a VOD server, web content provided by an Internet server, game content provided by a game server, etc.

In particular, the web content provided from the server has been in the limelight to keep up with networked display apparatuses, association with broadcast content, promotion of social network service (SNS) and the like trend, and is displayable in the display apparatus in real time. As a prime example of the web content, there is news, and the server periodically provides collected news articles to the display apparatus. The display apparatus displays the news articles from the server on the screen in the form of a user interface (UI). For example, the display apparatus divides the screen into a plurality of areas, and arranges content items corresponding to individual news articles in a plurality of divisional areas. The content items are displayed with only titles and partial descriptions of the news articles on the divisional areas. When a user selects a certain content item, the selected content item is displayed with the title and the whole description on a full screen.

Content items of news articles displayed by a conventional display apparatus are generally arranged based on a layout reflecting intention of the server or the content provider, and the display apparatus displays an image of the content items arranged based on the layout. However, the image of the news articles displayed as above does not provide information about a relationship between the news articles, such as, which one of the news articles is more recent, which one of the news articles is more popular, etc. to be intuitively recognizable by a user. For example, a conventional image provides information about dates according to news articles, such as a date when a news article was written, etc. Through the conventional image, a user can know a date of a news article, but it is difficult for the user to intuitively know which one is newer among many news articles provided by the display apparatus.

Accordingly, it would be preferable if a plurality of content items provided by the display apparatus is given to let a user intuitively know a comparative relationship between the content items.

### TECHNICAL SOLUTION

According to an embodiment of the disclosure, a display apparatus includes: a receiver configured to communicate with a server; a display including a screen on which an image is displayable; and a processor configured to identify property values about two or more properties with respect to a plurality of content items based on information received from the server, control the display to display the content items to be arranged at positions corresponding to the property values along different directions on the screen based on the properties, and rearranges the content items based on change in the property value as updated with information received from the server. Thus, the display apparatus allows a user to intuitively compare the content items in terms of a certain property with respect to the plurality of content items being displayed as an image.

Here, the processor may identify values respectively corresponding to the properties on a plurality of axes about the two or more properties, and arrange the content items at positions on the screen based on the identified values.

Further, the processor may adjust a display state of the content item, based on a property value about another property other than the two or more properties.

Here, the display state of the content item includes at least one of emphasis, highlight, color, transparency, size, or chroma of the content item.

Further, the processor may adjust a display state of a certain area of the content item adjacent to an edge of the screen based on a truncated part of the content item over the edge of the screen.

Here, the processor may increase transparency of the area of the content item adjacent to the edge as getting closer to the edge.

Further, the processor may store the plurality of content items given with serial numbers in a cache, and rotate and display the plurality of content items on the screen in order of the serial number every predetermined period of time.

Further, the display apparatus may further include a microphone configured to receive a user utterance, and the processor may recognize one or more words from the utterance received through the microphone, and automatically execute one content item including the recognized one or more words among the plurality of content items.

Here, the processor may compare and identify the plurality of words included in the utterance with the plurality of content items in sequence until the one content item is identified among the plurality of content items.

Further, the processor may receive the information including the content from the server every preset period of time.

Further, the processor may adjust at least one of a width or length of the content item displayed on the screen based on the number of content items received per unit time.

Further, a method of controlling a display apparatus includes: receiving information from a server; identifying property values about two or more properties with respect to a plurality of content items based on the information, and displaying an image of the screen by arranging the content items at positions corresponding to the property values along different directions on the screen based on the properties; and rearranging the content items on the screen based on change in the property value as updated with information received from the server.

Here, the displaying the image of the screen may include identifying values respectively corresponding to the properties on a plurality of axes about the two or more properties, and arranging the content items at positions on the screen based on the identified values.

Further, the method may further include adjusting a display state of the content item, based on a property value about another property other than the two or more properties.

Further, the method may further include adjusting a display state of a certain area of the content item adjacent to an edge of the screen based on a truncated part of the content item over the edge of the screen.

Further, the rearranging the content items on the screen may include storing the plurality of content items given with serial numbers in a cache, and rotating and displaying the plurality of content items on the screen in order of the serial number every predetermined period of time.

Further, the method may further include recognizing one or more words from an utterance received through a microphone, and automatically executing one content item including the recognized one or more words among the plurality of content items.

Further, the method may further include adjusting at least one of a width or length of the content item displayed on the screen based on the number of content items received per unit time.

Further, there is provided a nonvolatile computer-readable recording medium recorded with a program for a method executable by a processor of a display apparatus according to an embodiment of the disclosure, the method including: receiving information from a server; identifying property values about two or more properties with respect to a plurality of content items based on the information, and displaying an image of the screen by arranging the content items at positions corresponding to the property values along different directions on the screen based on the properties; and rearranging the content items on the screen based on change in the property value as updated with information received from the server.

### DESCRIPTION OF DRAWINGS

FIG. 1 illustrates a display apparatus according to an embodiment of the disclosure.

FIG. 2 illustrates a news content image displayed by a display apparatus according to an embodiment of the disclosure.

FIG. 3 illustrates that a news content image displayed by a display apparatus according to an embodiment of the disclosure is changed from a screen of FIG. 2.

FIG. 4 is a flowchart showing a method of controlling a display apparatus according to an embodiment of the disclosure.

FIG. 5 illustrates a structure for arranging content items in a screen by a display apparatus according to an embodiment of the disclosure.

FIG. 6 illustrates a method that a display apparatus according to an embodiment of the disclosure calculates popularity of a news article and identifies a position corresponding to the calculated popularity on a screen.

FIG. 7 illustrates that content items are changed in position as time passes on a screen of a display apparatus according to an embodiment of the disclosure.

FIG. 8 illustrates a principle that a display apparatus according to an embodiment of the disclosure periodically rotates some among a plurality of content items to be displayed on a screen.

FIG. 9 illustrates a method that a display apparatus according to an embodiment of the disclosure recognizes a user utterance and selects a certain content item.

FIG. 10 is a flowchart showing a method that a display apparatus according to an embodiment of the disclosure selects one among a plurality of content items based on a user utterance.

FIG. 11 illustrates a content image displayed by a display apparatus according to an embodiment of the disclosure.

FIG. 12 illustrates a news-content image displayed by a display apparatus according to an embodiment of the disclosure.

FIG. 13 illustrates that a display apparatus according to an embodiment of the disclosure keeps displaying some content items based on popularity of content items.

FIG. 14 illustrates that a display apparatus according to an embodiment of the disclosure changes widths of content items according to preset conditions.

FIG. 15 is a block diagram of a display apparatus according to an embodiment of the disclosure.

### BEST MODE

Below, embodiments of the present disclosure will be described in detail with reference to accompanying drawings. Further, the embodiments described with reference to the accompanying drawings are not exclusive to each other unless otherwise mentioned, and a plurality of embodiments may be selectively combined within one device. The combination of these plural embodiments may be discretionally selected and applied to realize the present inventive concept by a person having an ordinary skill in the art.

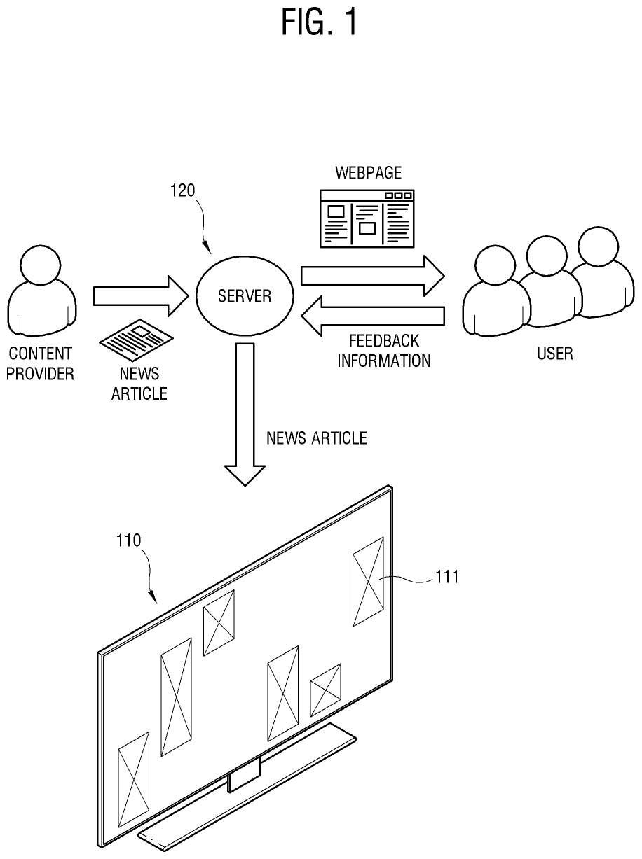

FIG. 1 illustrates a display apparatus according to an embodiment of the disclosure.

As shown in FIG. 1, a display apparatus 110 receives content from various content sources, and displays a content image by processing the received content. The display apparatus 110 according to this embodiment includes all the apparatuses capable of displaying an image, but an apparatus having a relatively large screen is suitable. It is not impossible to apply the concept of the disclosure to an apparatus having a relatively small screen like a portable multimedia device or a mobile phone, but the concept of the disclosure is more appropriate for the display apparatus 110 stationarily positioned and having a relatively large screen like a television (TV), a digital signage, an electronic frame, etc. by way of example. In this embodiment, it will be described that the display apparatus 110 is embodied by the TV.

The display apparatus 110 displays an image based on various kinds of content, and may display web content on the Internet as well as a full screen image based on a broadcast program or steaming content. This embodiment shows that the display apparatus 110 receives a news article among the various kinds of web content, but the kind of content is not limited to only news. Alternatively, any kind of content is possible as long as it can be divided and processed according to a plurality of categories or content items.

The display apparatus 110 accesses a content source, i.e. a server 120 through a network. The server 120 collects news articles from a plurality of content providers such as a newspaper. The server 120 may provide the collected news articles to a plurality of unspecified users. The plurality of unspecified users may feed information about the received news articles back to the server 120.

For example, the server 120 builds a webpage based on the news articles, and provides a webpage service to the users. The user reads the news articles of the provided webpage, determines preference scores for the news articles, whether to recommend the news articles, whether to share the news articles, etc. and feeds the determination back to the server 120. Further, the server 120 periodically combines and provides the collected news articles to the display apparatus 110.

The display apparatus 110 according to this embodiment performs the following operations to display a plurality of news articles on the screen. For example, when there is news content including the plurality of news articles, the news article is one of content items of the news content. One content item has values of various properties. For example, the news article has properties such as the written date, popularity, preference, category, number of user recommendations, etc. of the article.

Each of the plurality of content items 111 has a plurality of properties. The display apparatus 110 identifies property values about two or more properties with respect to the content items 111 of the content based on information received from the server 120, displays the content items 111 to be arranged at positions corresponding to the property values along different directions on the screen according to the properties, and rearranges the content items 111 based on change in the property value as updated with information received from the server 120.

The display apparatus 110 sets a plurality of axes with respect to the properties on the screen. The display apparatus 110 identifies values respectively corresponding to the properties of a certain content item 111 on the plurality of different axes on the screen, arranges the content item 111 at a position on the screen corresponding to the values, and displays an image including the plurality of content items 111. Further, the display apparatus 110 controls the content items 111 to be rearranged at the positions based on change in the properties of the plurality of content items 111.

Thus, the display apparatus 110 according to this embodiment allows a user to be intuitively aware of a comparative relationship among the plurality of provided content items 111 according to the properties.

Below, a method that the display apparatus 110 displays a content image will be described in detail.

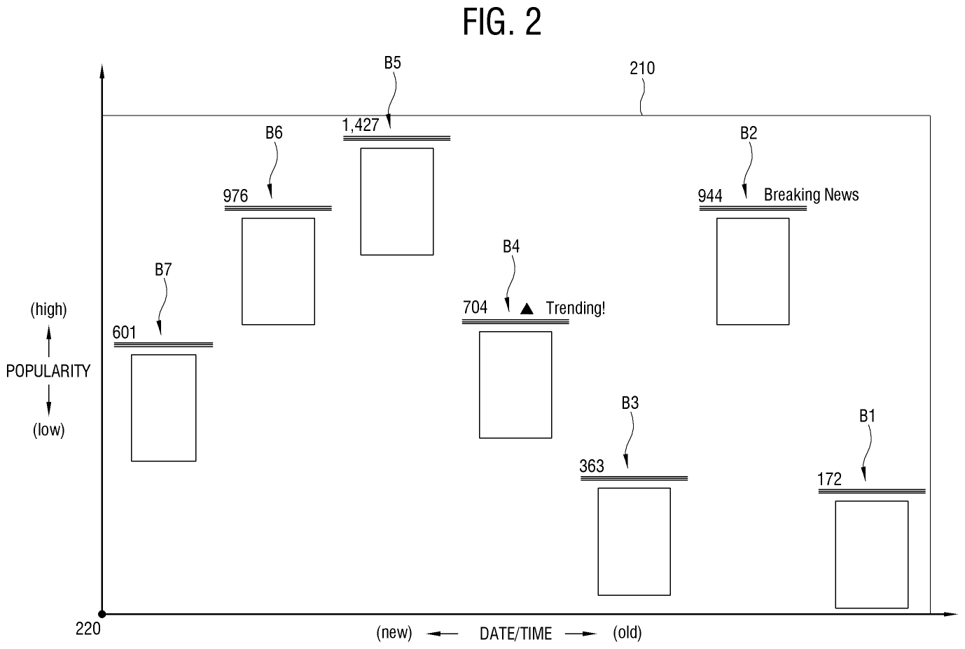

FIG. 2 illustrates a news content image displayed by a display apparatus according to an embodiment of the disclosure.

As shown in FIG. 2, the display apparatus displays a news content image on a screen 210. The news content image includes the plurality of article content items B1, B2, B3, B4, B5, B6 and B7. Each of the content items B1, B2, B3, B4, B5, B6 and B7 includes information about some content of a corresponding article, for example, at least a part of a title of a news article, some content of the news article, i.e. description, and popularity information about the news article. It is possible to variously design and change what information the content items B1, B2, B3, B4, B5, B6 and B7 will show. However, the information may include at least the title of the article so that a user can roughly understand what the corresponding article is about.

The display apparatus according to this embodiment arranges the content items as follows. The display apparatus sets a horizontal axis and a vertical axis with respect to a certain position on the screen 210 regarded as an origin 220. For example, when the left bottom apex of the screen 210 is set as the origin 220, the horizontal axis is the bottom edge of the screen 210 and the vertical axis is the left edge of the screen 210.

The display apparatus assigns predetermined first and second properties among many properties of the content items B1, B2, B3, B4, B5, B6 and B7 to the horizontal axis and the vertical axis, respectively. In this case, a predetermined position on the horizontal axis corresponds to a predetermined value of the first property, and a predetermined position on the vertical axis corresponds to a predetermined value of the second property.

For example, the properties of the content items B1, B2, B3, B4, B5, B6 and B7 include comparative dates and times of the news articles and the popularity of the news articles. The date/time of the news article may be based on a date/time when the news article was first generated, or may include an index value given at a point in time when the display apparatus receives the news article. When the comparative date/time of the news article corresponds to the horizontal axis, the news article is more up-to-date as its position value becomes closer to the origin 220 on the horizontal axis, and is more out-of-date as its position value becomes far away from the origin 220 on the horizontal axis.

Further, the popularity of the news article may refer to a user score, the number of views, the number of sharing times in social network service (SNS), the number of recommendation times, or a score calculated based on at least two among them, which are given to the article when the corresponding article is provided to a plurality of unspecified users by the server. When the popularity of the news article corresponds to the vertical axis, the news article has higher popularity as its position value becomes closer to the origin 220 on the vertical axis, and has lower popularity as its position value becomes far away from the origin 220 on the vertical axis.

The display apparatus identifies a value on the horizontal axis corresponding to the date/time and a value on the vertical axis corresponding to the popularity with regard to one of the content items B1, B2, B3, B4, B5, B6 and B7, and locates the content item B1, B2, B3, B4, B5, B6 or B7 at the position on the screen 210 where two values meet. In this manner, the display apparatus displays an image of the screen 210 by arranging the plurality of content items B1, B2, B3, B4, B5, B6 and B7 on the screen 210.

Such a displayed image intuitively shows comparison in properties between the plurality of content items B1, B2, B3, B4, B5, B6 and B7. For example, the third content item B5 from the left is located at the highest position among seven content items B1, B2, B3, B4, B5, B6 and B7 displayed on the screen 210, and it is therefore easy for a user to be aware that the content item B5 has the highest popularity among all the displayed content items B1, B2, B3, B4, B5, B6 and B7.

Meanwhile, the display apparatus periodically receives news content from the server. The display apparatus may obtain two types of information from newly received news content, in which one is new news article that has not been previously received, and the other one is a new value of a predetermined property of the news article that has been previously received. That is, the newly received content includes new content items B1, B2, B3, B4, B5, B6 and B7 as compared with the content that has been received at a previous point in time, or includes new property values of the existing content items B1, B2, B3, B4, B5, B6 and B7.

In the former case, when news content received at a predetermined first point in time is compared with news content received at a predetermined second point in time after the first point in time, there may be a news article received only at the second point in time besides the duplicated news articles. In the latter case, with regard to a news article that belongs to both the news content at the first point in time and the news content at the second point in time, the corresponding news article at the second point in time may be different in popularity from that at the first point in time.

Thus, when the properties of the content items B1, B2, B3, B4, B5, B6 and B7 are changed based on the newly received content, the display apparatus rearranges the positions of the plurality of content items B1, B2, B3, B4, B5, B6 and B7 in the screen 210 by reflecting the hanged properties. Thus, a user can be aware in real time that the properties of the plurality of content items B1, B2, B3, B4, B5, B6 and B7 are changed.

Below, the rearrangement of the content items B1, B2, B3, B4, B5, B6 and B7 will be described.

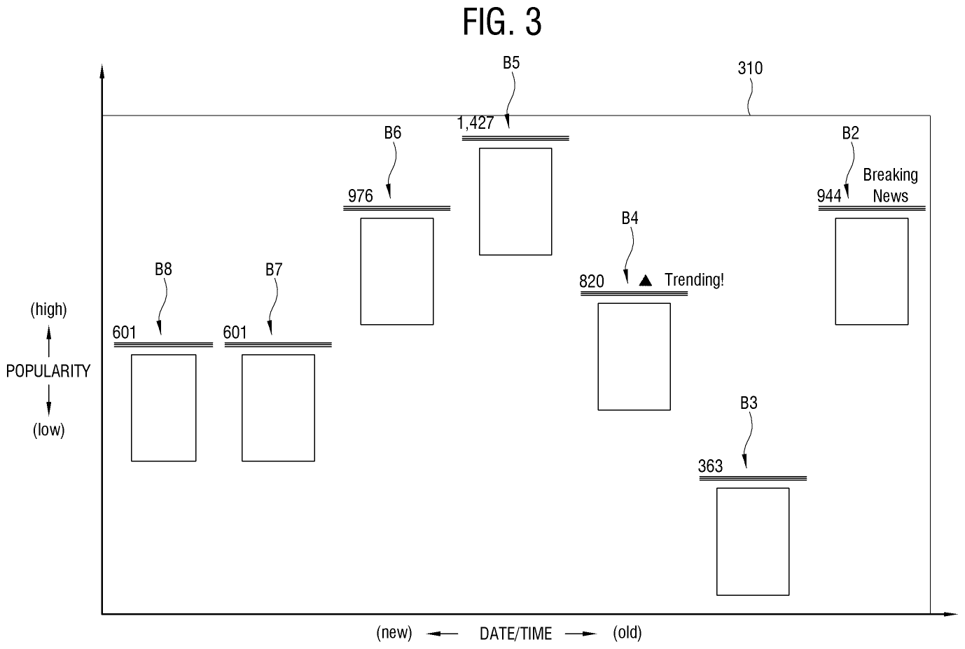

FIG. 3 illustrates that a news content image displayed by a display apparatus according to an embodiment of the disclosure is changed from a screen of FIG. 2.

As shown in FIG. 3, a plurality of content items B2, B3, B4, B5, B6, B7 and B8 are rearranged on a screen 310 based on the content received at the second point in time. When the content received at the second point in time includes a new content item B8, the display apparatus adds the content item B8 of the most recent date/time at the leftmost position and instead deletes the content item B1 (see FIG. 2) of the oldest date/time from the previous screen of the FIG. 2. In comparison between the current screen 310 and the previous screen of FIG. 2, the previously displayed content items B2, B3, B4, B5, B6 and B7 are moved rightward, and the rightmost content item B1 is excepted from the screen 310 while newly adding the newest content item B8 to the leftmost position.

Such a change in the screen 310 is caused by change in the property values corresponding to the comparative dates and times of the content items B2, B3, B4, B5, B6 and B7. Because the property values about the comparative dates and times of the previous content items B1, B2, B3, B4, B5, B6 and B7 are changed as the up-to-date content item B8 is added, the display apparatus readjusts the positions of the content items B2, B3, B4, B5, B6, B7 and B8 based on such a change in the property values.

Meanwhile, when the content received at the second point in time includes the previous content items B2, B3, B4, B5, B6 and B7 changed in popularity, the display apparatus adjusts the values of the content items B2, B3, B4, B5, B6, B7 and B8 on the vertical axis based on the changed popularity of each of the content items B2, B3, B4, B5, B6, B7 and B8. Therefore, the high and low positions of the content items B2, B3, B4, B5, B6, B7 and B8 arranged on the screen 310 are changed based on the updated popularity. For example, the popularity of the content item B4 becomes higher from ‘704’ at the previous first point in time (see FIGS. 2) to ‘820’ at the current second point in time. Therefore, the position of the content item B4 is also changed to be higher than that at the first point in time.

Like this, the display apparatus according to this embodiment allows a user to be intuitively aware of the comparative change in date/time and popularity between the continuously created news articles.

Below, a method of controlling a display apparatus will be described.

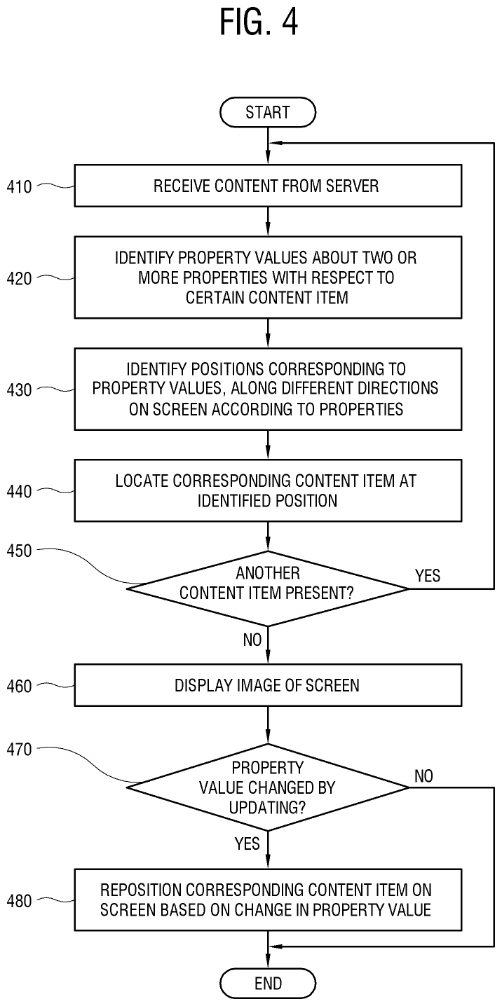

FIG. 4 is a flowchart showing a method of controlling a display apparatus according to an embodiment of the disclosure.

As shown in FIG. 4, at operation 410 the display apparatus receives content including a plurality of content items from a server.

At operation 420 the display apparatus identifies property values about two or more properties with respect to a certain content item among the plurality of content items.

At operation 430 the display apparatus identifies positions corresponding to the identified property values, along different directions on the screen according to the properties.

At operation 440 the display apparatus locates the corresponding content item at the identified position.

At operation 450 the display apparatus identifies whether there is another content item to be displayed. When there is another content item which has not been displayed yet, the display apparatus moves to the operation 420 with regard to the corresponding content item.

When all the necessary content items are completely arranged, at operation 460 the display apparatus displays an image where the content items are arranged on the screen.

At operation 470 the display apparatus identifies whether there is change in a property value about at least one content item as the content received from the server is updated. When it is identified that there is no change in the property value, the display apparatus maintains a current displaying state.

On the other hand, when it is identified that there is change in the property value, at operation 480 the display apparatus repositions the corresponding content item on the screen based on the change in the property value.

Thus, the display apparatus allows a user to be intuitively aware of the change in the property value according to the content items in real time.

Below, a structure of a screen, which includes content items, in a display apparatus will be described.

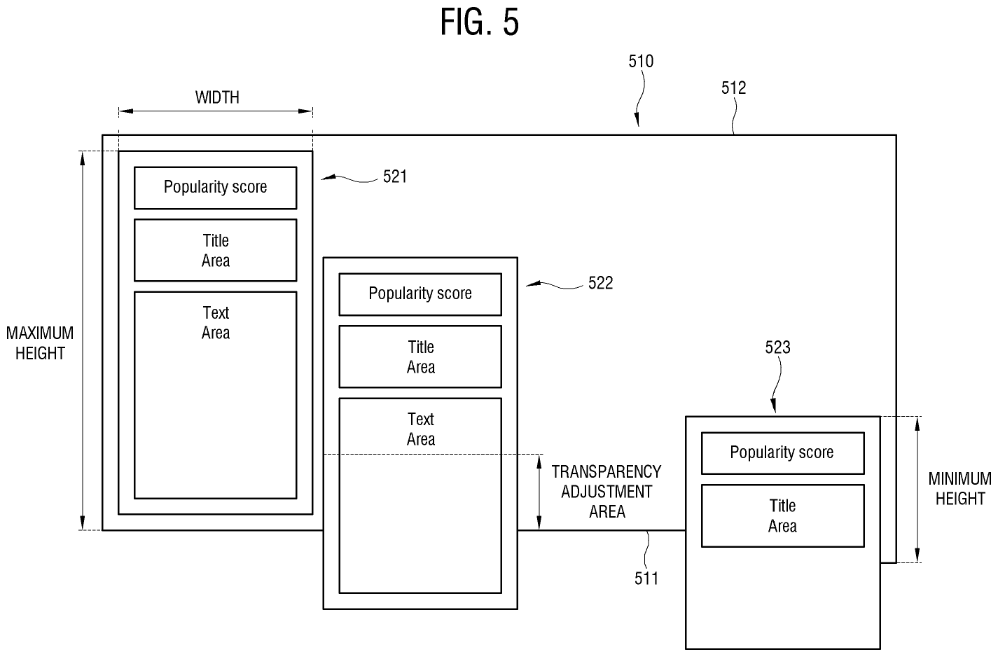

FIG. 5 illustrates a structure for arranging content items in a screen by a display apparatus according to an embodiment of the disclosure.

As shown in FIG. 5, a display apparatus rearranges a plurality of content items 521, 522 and 523 in a screen 510. The content items 521, 522 and 523 have the same width, but different lengths according to their content. A total number of content items 521, 522 and 523 displayable on the screen 510 is varied depending on the width of the content items 521, 522 and 523 and the width of the screen 510, and is thus not limited to a specific value.

In a case of news content, each of the content items 521, 522 and 523 may for example be divided into a popularity score in which popularity of an article is represented with a numeral or the like, a title area in which the title of the article is displayed, and a text area in which at least some content, i.e. description of the article is displayed. There are no limits to such division, and the division may be set when the display apparatus is designed, or may be variously set by a user's control.

As described in the foregoing embodiment, each height of the content items 521, 522 and 523 in the screen 510 is identified based on the popularity of the corresponding news article. Here, the height in the screen 510 corresponds to a distance from the bottom edge 511 of the screen 510. In other words, a higher position of the content item 521 in the screen 510 means nearness to a top edge 512 of the screen 510, and a lower position of the content item 523 in the screen 510 means nearness to the bottom edge 511 of the screen 510.

However, the display apparatus sets the maximum height and the minimum height in terms of arranging the content items 521, 522 and 523, and restricts the reference positions of the content items 521, 522 and 523 between the maximum height and the minimum height. The maximum height and the minimum height are based on the bottom edge 511 of the screen 510. The reference positions of the content items 521, 522 and 523 may for example refer to the upper edges of the content items 521, 522 and 523.

In other words, the display apparatus prevents the upper edge of the content item 521 from getting closer to the top edge 512 of the screen 510 without leaving a predetermined margin no matter how high the popularity of the content item 521 is. Further, the display apparatus prevents the upper edge of the content item 523 from getting closer to the bottom edge 511 of the screen 510 without leaving a predetermined margin no matter how low the popularity of the content item 523 is. That is, the upper edges of the content items 521, 522 and 523 are arranged between a preset maximum height and a preset minimum height.

Meanwhile, according to content of the news article, the content item 522 may partially pass the bottom edge 511 of the screen 510. For example, the content items 521, 522 and 523 may go beyond the bottom edge 511 the screen 510. In this case, the display apparatus needs to notify a user that a part of the content item 522 is truncated in the current screen 510. There may be various notification methods.

As one of the methods, when an area of the content item 522 present within a predetermined distance from the bottom edge 511 of the screen 510 is called a transparency adjustment area, the display apparatus controls the transparency of the transparency adjustment area to gradually increase as it gets closer to the bottom edge 511 of the screen 510. The display apparatus controls the transparency adjustment area to become completely transparent at the bottom edge 511 of the screen 510, i.e. to have a transparency of ‘100’.

For example, the transparency in the transparency adjustment area may be identified as follows. When ‘edge0’ indicates the height of the lower edge of the transparency adjustment area and ‘edge1’ indicates the height of the upper edge of the transparency adjustment area, the transparency is expressed by [x=(height−edge0)/(edge1−edge0)]. In this expression, the ‘height’ refers to the height of a target position. The transparency of the target position is 3(x\hat{ }2)−2(x\hat{ }3) at 0<x≤1, 0 at x≤0, and 1 at x>1. However, this method is merely an example, and the transparency control method is not limited to this example.

As another method, the display apparatus may display an image of which meaning is easily understood by a user like a downward arrow in a certain area of the content item 522 near the bottom edge 511 of the screen 510. Thus, a user can be aware of that image displayed in a lower side of the content item 522, and intuitively know that parts of the content items 521, 522 and 523 are truncated.

In the foregoing embodiment, the display apparatus identifies each height of the content items 521, 522 and 523 based on the popularity of the plurality of content items 521, 522 and 523, and arranges the content items 521, 522 and 523 on the screen 510 based on the identified height. Below, a method that the display apparatus calculates each popularity of the content items 521, 522 and 523 will be described.

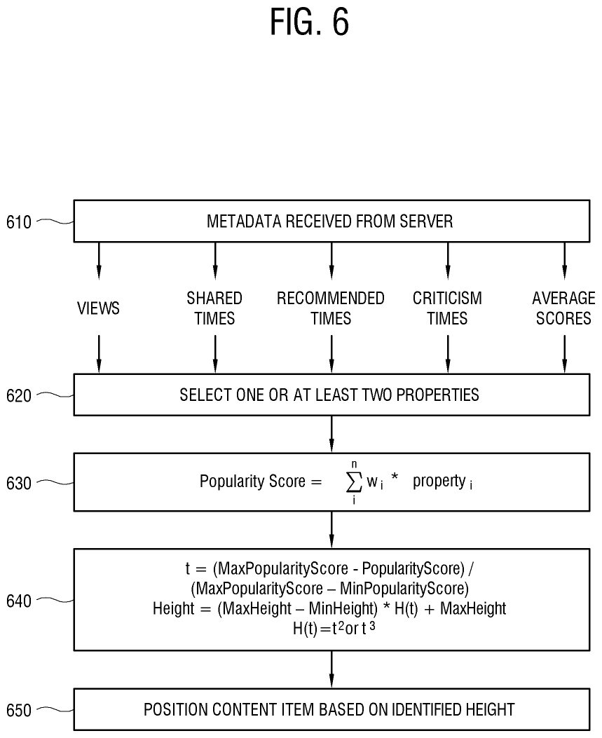

FIG. 6 illustrates a method that a display apparatus according to an embodiment of the disclosure calculates popularity of a news article and identifies a position corresponding to the calculated popularity on a screen.

As shown in FIG. 6, the display apparatus may calculate popularity of a news article based on metadata or the like information provided from the server with regard to the corresponding news article. Alternatively, the display apparatus may not calculate the popularity but use the popularity calculated by the server. However, this embodiment will describe that the display apparatus calculates the popularity.

There are many properties of a news article with regard to popularity, for example, the number of views which indicates how many people views the news article, the number of sharing times which indicates how many people shares the news article with others, the number of recommendation times which indicates how many people recommends the news article, the number of criticism times which indicates how many people criticizes the news article, an average score which indicates an average of scores given to the news article by people, etc.

When metadata is received from the server (610), the display apparatus selects one or at least two properties among these properties obtained from the metadata (620). The display apparatus may select only one property, may select two properties, and may select every possible property. In this embodiment, it will be described that a plurality of properties is selected.

The plurality of selected properties are weighted and aggregated by the display apparatus (630). In the expression of the operation 630 shown in FIG. 6, ‘Popularity Score’ indicates the popularity of the news article, wᵢ indicates weight of a property, and propertyᵢ indicates a property value. For example, when two properties, i.e. a first property having a first property value and a second property having a second property value are selected, and the first and second properties are respectively weighted with a first weight and a second weight, the popularity of a certain news article is calculated by [(first weight*first property value)+(second weight*second property value)]. The weight of each property is based on a previously set value.

The display apparatus identifies the height, i.e. The position of the content item corresponding to the news article in the screen based on the calculated popularity (640). In the expression of the operation 640 shown in FIG. 6, ‘MaxPopularityScore’ indicates the highest popularity score among popularity scores of all content items targeted to be displayed on the screen, ‘MinPopularityScore’ indicates the lowest popularity score among the popularity scores of all the content items targeted to be displayed on the screen, and ‘PopularityScore’ indicates the popularity score of the target content item. For example, when there are seven content items to be displayed on the screen, ‘MaxPopularityScore’ indicates the highest popularity score among the popularity scores of the seven content items, and ‘MinPopularityScore’ indicates the lowest popularity score.

In the expression, ‘height’ indicates the height of the target content item, ‘MaxHeight’ indicates the maximum height at which the reference position of the content item can be located, and ‘MinHeight’ indicates the minimum height at which the reference position of the content item can be located. ‘H(t)’ indicates a height identifying function which can be provided in various forms besides a quadric function and a cubic function.

The display apparatus positions the content item in the screen based on the identified height (650). The display apparatus arranges all the target content items in a screen and displays an image of the screen.

Below, a method that the display apparatus changes the position of each content item on the screen as time passes will be described.

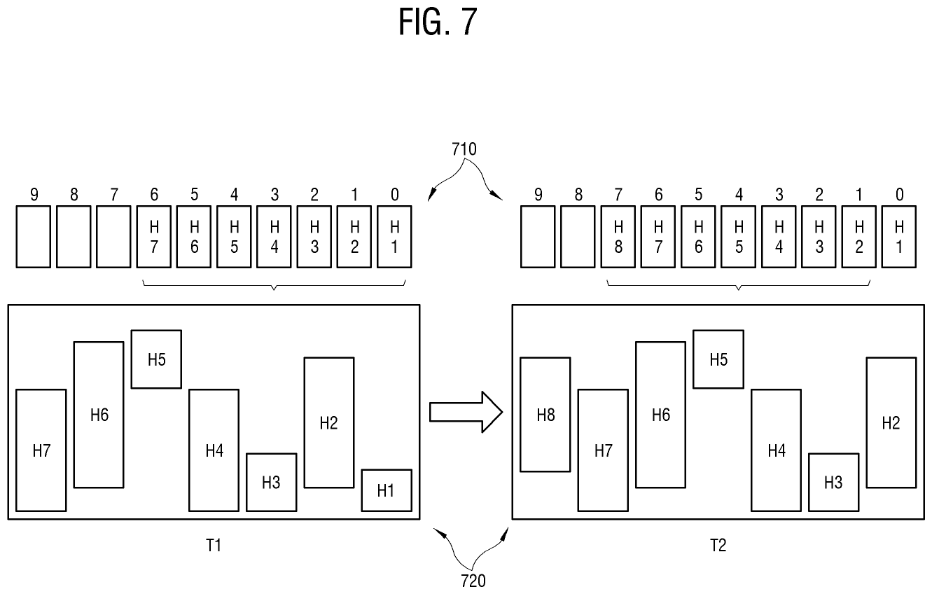

FIG. 7 illustrates that content items are changed in position as time passes on a screen of a display apparatus according to an embodiment of the disclosure.

As shown in FIG. 7, the display apparatus has a cache 710 for storing content items in a memory, a storage or a buffer. The cache 710 has slots in which the content items are stored, and one slot is configured to store one content item. For example, the cache 710 has ten slots numbered from 0 through 9, and is thus configured to store at most ten content items.

When the display apparatus receives seven content items H1, H2, H3, H4, H5, H6, H7 of content at a point in time T1, allocation of the content items starts from the slot No. 0 in order of older date/time. The display apparatus starts allocating the slot No. 0 to the content item H1 of the oldest date/time, and thus fills the slots Nos. ‘0’ to ‘6’ with the content items H1 to H7, respectively. The display apparatus displays such content items respectively stored in the slots on a screen 720. A method of displaying the content items on the screen 720 is the same as described above.

At a point in time T2 after the point in time T1, the display apparatus receives updated content. When the updated content includes a new content item H8, the display apparatus fills an empty slot of the cache 710 with the content item H8. Before the point in time T2, the slots Nos. ‘0’ to ‘6’ are filled with the content items, and the slots Nos. ‘7’ to ‘9’ are empty. Thus, the display apparatus fills the content item H8 in the slot No. 7.

Like this, the display apparatus rearranges the content items in the screen as the storage state of the cache 710 is updated. Because the content item H8 that has not been present at the point in time T1 is newly created, the display apparatus adds the content item H8 at the leftmost position on the screen 720. The display apparatus deletes the content item H1 of the oldest date/time from the screen 720 of the point in time T1, and moves the content items H2 to H7 rightward. Thus, on the screen 720 of the point in time T2, the content item H2 of the oldest date/time among the content item H2 to H8 is located at the rightmost position, and the content items H3 to H8 are sequentially arranged in a leftward direction.

Thus, the display apparatus repositions the content items as the content is updated.

Meanwhile, there may be various processing methods when a new content item is received while all the slots of the cache 710 are filled with the content items.

For example, when a new content item is received in the state that the slots of the cache 710 are all occupied, the display apparatus empties out all the slots of the cache 710 in a lump and then fills the slots with the new content items.

Alternatively, the display apparatus may empty out the slots Nos. ‘0’ to ‘N’ among the slots of the cache 710, refill the empty slots with the content items of the slots Nos. ‘(N+1)’ to ‘M’ starting from the slot No. ‘0’, and fill the new content items in the empty slots. Here, ‘M’ and ‘N’ are natural numbers, ‘M’ is the last number of the slot, and ‘N’ is smaller than or equal to ‘M’.

Meanwhile, the display apparatus may display a plurality of content items as moved in the screen every predetermined time interval. Below, such an embodiment will be described.

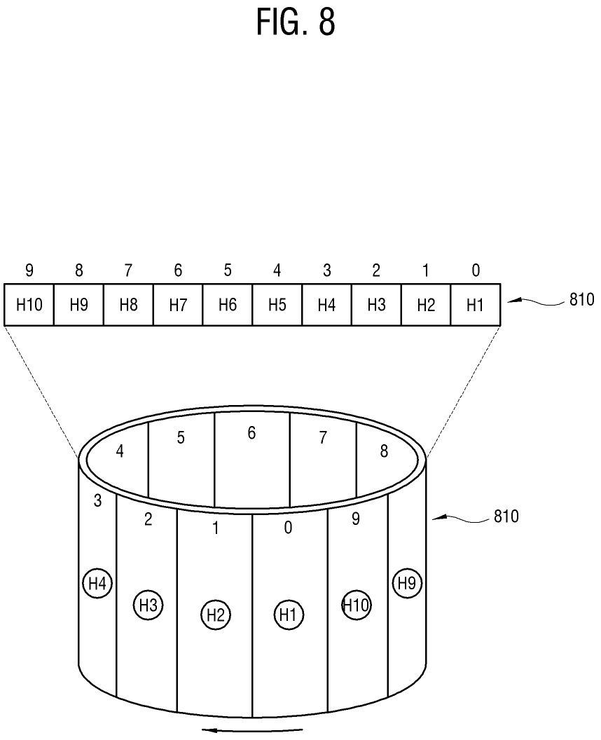

FIG. 8 illustrates a principle that a display apparatus according to an embodiment of the disclosure periodically rotates some among a plurality of content items to be displayed on a screen.

As shown in FIG. 8, the display apparatus includes a cache having slots Nos. ‘0’ to ‘9’ to store the content items. The number of slots is merely an example, and does not limit the concept of the disclosure.

In a case where seven content items are displayed on the screen, the display apparatus selects the content items of the slots Nos. ‘0’ to ‘6’ at a predetermined first point in time, and displays the content items H1 to H7 on the screen. The display apparatus selects new slots by adding a predetermined natural number, e.g. ‘1’ to each of the selected slot numbers every predetermined period of time. For example, the slot No. 1 is selected by adding ‘1’ to the index number of the slot No. ‘0’, the slot No. 2 is selected by adding ‘1’ to the index number of the slot No. ‘1’, and the slot No. 7 is selected by adding ‘1’ to the index number of the slot No. ‘6’.

Therefore, the display apparatus selects the content items of the slots Nos. ‘1’ to ‘7’ at a second point in time after the first point in time, selects the content items of the slots Nos. ‘2’ to ‘8’ at a third point in time after the second point in time, and selects the content items of the slots Nos. ‘3’ to ‘9’ at a fourth point in time after the third point in time,

When there is an empty slot filled with no content items, only the slots filled with the content items are targeted for the process except the empty slot.

The slot No. ‘9’ is the slot of the last index number in the cache 810. Here, a slot subsequent to the slot No. ‘9’ is the slot of the first index number, i.e. The slot No. ‘0’. In comparison to a cylinder formed by sequentially arranging the slots, the slot No. ‘9’ and the slot No. ‘0’ are adjacent to each other in the cylinder. In this manner, the display apparatus selects the content items of the slots Nos. ‘4’ to ‘9’ and ‘0’ at a fifth point in time after the fourth point in time.

Thus, the display apparatus selects the slots filled with the content items every predetermined period of time, and displays the content items of the selected slots on the screen. A method of displaying the content items is the same as that described in the foregoing embodiment, and thus detailed descriptions thereof will be omitted.

As described in the foregoing embodiments, the display apparatus displays the content items of the news articles of news content. When a certain content item is selected among the displayed content items, the display apparatus switches a screen over to a main page of the news article of the selected content item. To select a certain content item, a user may control a remote controller. When a user cannot use the remote controller, the user's utterance may be recognized. Below, such an embodiment will be described.

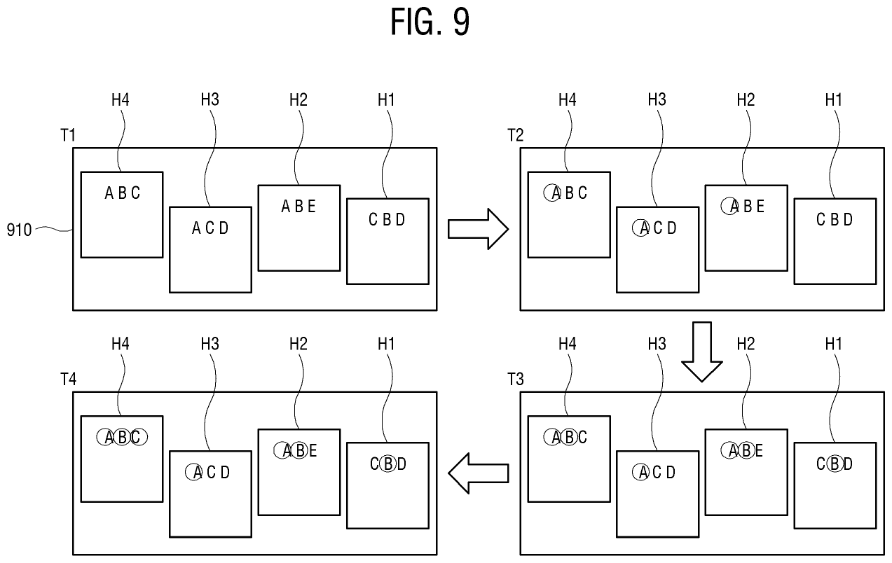

FIG. 9 illustrates a method that a display apparatus according to an embodiment of the disclosure recognizes a user utterance and selects a certain content item.

As shown in FIG. 9, the display apparatus displays four content items H1, H2, H3 and H4 on a screen 910 at a point in time T1. Each content item has a title. For example, the content item H1 has a title of ‘C B D’, the content item H2 has a title of ‘A B E’, the content item H3 has a title of ‘A C D’, and the content item H4 has a title of ‘A B C’. To clarify the embodiment of the disclosure, predetermined words in the titles were simplified into ‘A’, ‘B’, etc. Here, ‘A’, ‘B’ and ‘C’ in the titles of the content item may refer to any words, respectively. However, when two content items have some of ‘A’, ‘B’ and ‘C’ in common with each other, it means that there are common words in the titles of the two content items. For example, both the title of the content item H1 and the title of the content item H2 have a common word of ‘B’.

It will be assumed that a user utters a word ‘A’ in a state that the content items are displayed on the screen 910 at a point in time T1. The display apparatus identifies the content items having the titles including the word ‘A’ uttered by the user among the content items H1, H2, H3 and H4 at a point in time T2 after the point in time T1. In this embodiment, the titles of the content items H2, H3 and H4 include the word ‘A’. The display apparatus emphasizes or highlights the word ‘A’ in the titles of the content items H2, H3 and H4, thereby notifying the user of the current state. Alternatively, the display apparatus may be designed not to emphasize or highlight the word.

When a user utters a word ‘B’ after the word ‘A’, the display apparatus identifies the content items having the titles including the new word ‘B’ among the content items H2, H3 and H4 including the word ‘A’ at a point in time T3 after the point in time T2. In this embodiment, the content items H2 and H4 include the words ‘A’ and ‘B’, and thus the display apparatus highlights the words ‘A’ and ‘B’ in the titles of the content items H2 and H4.

When a user utters a word ‘C’ after the words ‘A’ and ‘B’, the display apparatus identifies the content item having the title including the new word ‘C’ among the content items H2 and H4 including the words ‘A’ and ‘B’ at a point in time T4 after the point in time T3. In this embodiment, only one content item H4 includes the words ‘A’, ‘B’ and ‘C’, and thus the display apparatus automatically selects the content item H4 and switches the screen 910 over to the content image of the content item H4.

Like this, when the content items having the titles including the words consecutively uttered by a user are converged into one content item, the display apparatus selects the one content item. Thus, the display apparatus may select a content item corresponding to an utterance of a user among a plurality of content items.

In this embodiment, the display apparatus identifies the word in the title of the content item. However, the word may be identified within various pieces of information contained in the content item without being limited to the title of the content item.

Below, a method of controlling the display apparatus according to this embodiment will be described.

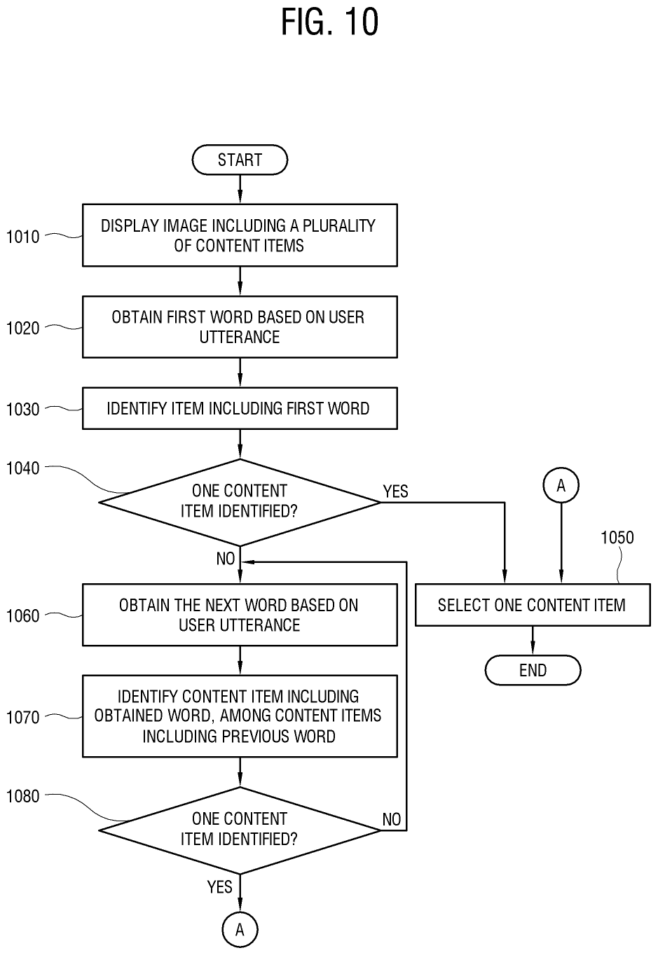

FIG. 10 is a flowchart showing a method that a display apparatus according to an embodiment of the disclosure selects one among a plurality of content items based on a user utterance.

As shown in FIG. 10, at operation 1010 the display apparatus displays an image including a plurality of content items corresponding to content.

At operation 1020 the display apparatus obtains the first word recognized based on a user utterance.

At operation 1030 the display apparatus identifies a content item including the first word among the plurality of content items.

At operation 1040 the display apparatus identifies whether there is only one identified content item.

When there is only one identified content item, at operation 1050 the display apparatus selects the one content item.

On the other hand, when there is not just one identified content item, at operation 1060 the display apparatus obtains the next recognized word based on a user utterance.

At operation 1070 the display apparatus identifies a content item including the obtained word among the content items including the previous word.

At operation 1080 the display apparatus identifies whether there is one identified content item.

When there is one identified content item, the display apparatus returns to the operation 1050.

When there is not one identified content item, the display apparatus returns to the operation 1060.

Thus, the display apparatus easily selects a content item based on a user utterance.

Meanwhile, the foregoing embodiments showed that the content items are arranged on the screen based on the axes of two different directions. For example, a news article is located at a position on the screen where a value on the horizontal axis corresponding to the date/time of the news article meets a value on the vertical axis corresponding to the popularity of the new article. However, the display apparatus may display an image of a screen by additionally reflecting a new property to such a screen state. Below, such an embodiment will be described.

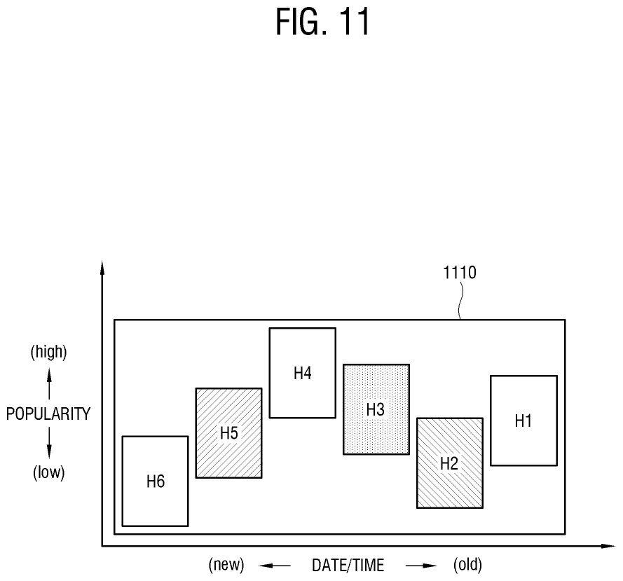

FIG. 11 illustrates a content image displayed by a display apparatus according to an embodiment of the disclosure.

As shown in FIG. 11, the display apparatus displays content items H1, H2, H3, H4, H5 and H6 about a plurality of news articles corresponding to news content on a screen 1110. The display apparatus sets the horizontal axis for the date/time of the news article and the vertical axis for the popularity of the news article on the screen 1110, and displays the content items H1, H2, H3, H4, H5 and H6 on the screen 1110 based on the property values of the content items H1, H2, H3, H4, H5 and H6. The state of using the horizontal axis and the vertical axis shows only two properties, i.e. The date/time and the popularity of the content items H1, H2, H3, H4, H5 and H6, but additional properties may be shown through not only the positions of the content items H1, H2, H3, H4, H5 and H6 in the screen 1110 but also the display states of the content items H1, H2, H3, H4, H5 and H6.

The properties of the news article may include a news category, a district related to news, how urgent news is, an increasing rate of popularity of news, etc. as well as the date/time and popularity of the news. The display apparatus may represent the date/time of the news and the popularity of the news by the positions where the content items H1, H2, H3, H4, H5 and H6 are arranged on the screen 1110, and additionally represent another property by the display states of the content items H1, H2, H3, H4, H5 and H6.

The display states of the content items H1, H2, H3, H4, H5 and H6 may include the emphasis or highlight on the content items H1, H2, H3, H4, H5 and H6; the colors of the content items H1, H2, H3, H4, H5 and H6; the transparency of the content items H1, H2, H3, H4, H5 and H6; the sizes of the content items H1, H2, H3, H4, H5 and H6, the chroma of the content items H1, H2, H3, H4, H5 and H6. The display apparatus may be previously set to identify or control such a display state of the content items H1, H2, H3, H4, H5 and H6.

As an example of the news categories, the news article may be classified into various categories such as politics, society, sports, life, leisure, etc. and each category is set to have a matching color. The display apparatus identifies the categories of the content items H1, H2, H3, H4, H5 and H6, and displays the content items H1, H2, H3, H4, H5 and H6 with the colors matching the identified categories. When the politics category, the society category and the sports category are respectively set to have a first color, a second color and a third color, the display apparatus displays the content item H3 corresponding to the politics category with the first color, the content items H2 and H5 corresponding to the society category with the second color, and the content items H1, H4 and H6 corresponding to the sports category with the third color. Thus, a user can be intuitively aware of which content item H1, H2, H3, H4, H5 or H6 of which category has high popularity based on the image of the screen 1110.

As an example of the increasing rate of popularity of news, the news articles having high popularity may include news articles of which popularity is gently increased, and news articles of which popularity is suddenly increased as they attract social attention. The increasing rate of the popularity may be represented with change in popularity for a preset period of time, and it is identified that the popularity is suddenly increased when this change is greater than a predetermined threshold.

When it is identified that popularity of a certain content item H1, H2, H3, H4, H5 or H6 is suddenly increased, the display apparatus emphasizes or highlights the content item H1, H2, H3, H4, H5 or H6. Thus, a user is easily aware that the content item H1, H2, H3, H4, H5 or H6 is currently attracting social attention.

The display apparatus may add another image to the content item H1, H2, H3, H4, H5 or H6 in addition to control of the display state of the content item H1, H2, H3, H4, H5 or H6, thereby representing the additional property of the content item H1, H2, H3, H4, H5 or H6 through the additional image. For example, to represent the sudden increase of the popularity, a red arrow image having a high attention level may be added to the number indicating the popularity of the content item H1, H2, H3, H4, H5 or H6.

Meanwhile, the foregoing embodiments showed that the left bottom apex of the screen is set as the origin for the axes corresponding to the properties, the horizontal axis is the bottom edge of the screen, and the vertical axis is the left edge of the screen. However, there are no limits where the origin and the axes are positioned on the screen, and various alternative embodiments are possible. Below, such an embodiment will be described.

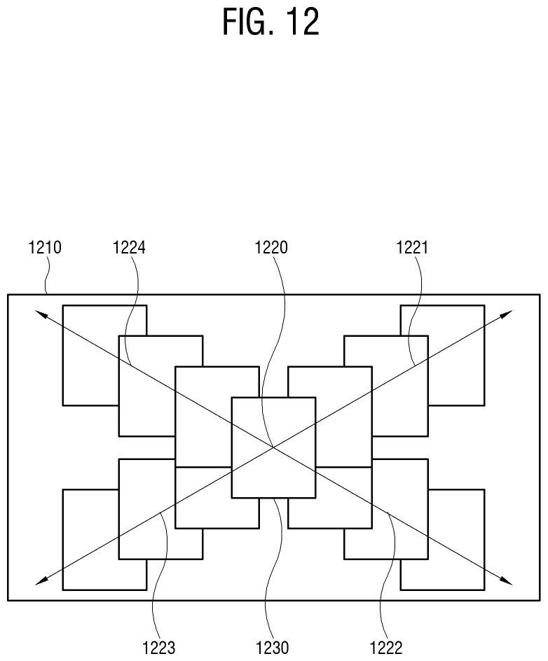

FIG. 12 illustrates a news-content image displayed by a display apparatus according to an embodiment of the disclosure.

As shown in FIG. 12, the display apparatus positions a plurality of content items 1230 on a screen 1210, and displays an image of the screen 1210. The display apparatus sets an origin 1220 in a center area of the screen 1210, and sets a first axis 1221 directed from the origin 1220 toward the top right apex of the screen 1210, a second axis 1222 directed toward the bottom right apex, a third axis 1223 directed toward the bottom left apex, and a fourth axis 1224 directed toward the top left apex.

The properties to be shown in the screen 1210 includes the date/time of a content item 1230 and the categories of the content item 1230. Regarding the date/time of the content item 1230, the most up-to-date content item 1230 is positioned at the origin 1220 or adjacent to the origin 1220, but the older content items 1230 are arranged at axial positions far away from the origin 1220.

Regarding the categories of the content item 1230, for example, the first axis 1221 may be assigned to a politic category, the second axis 1222 may be assigned to an economic category, the third axis 1223 may be assigned to a cultural category, and the fourth axis 1224 may be assigned to an art category. The display apparatus arranges the content items 1230 of the cultural category on the third axis 1223, and arranges the content item 1230 of the art category on the fourth axis 1224.

Thus, the up-to-date content items 1230 are gathered close to the origin 1220, but the content items 1230 are dispersed according to the categories as time passes. Thus, a user can be easily aware of article flow according to the categories of the plurality of content items 1230.

Meanwhile, the foregoing embodiment showed that the plurality of content items is moved from left to right on the screen as time passes, and the oldest content item among the displayed content items is not displayed on the screen. However, another embodiment is possible based on the popularity of the content item, and thus such an embodiment will be described below.

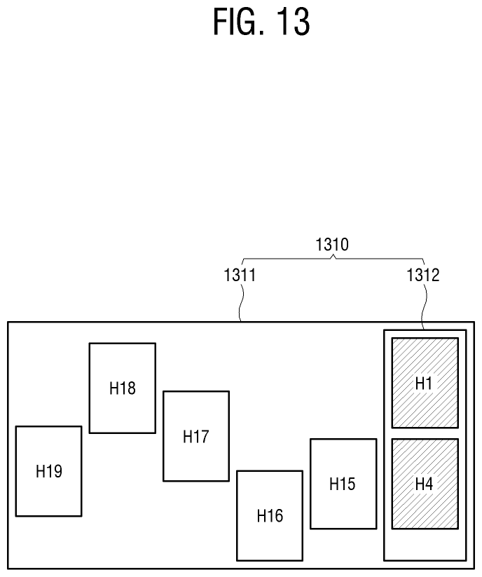

FIG. 13 illustrates that a display apparatus according to an embodiment of the disclosure keeps displaying some content items based on popularity of content items.

As shown in FIG. 13, a screen 1310 is divided into a first area 1311 and a second area 1312. Regarding the first area 1311, the display apparatus arranges a plurality of content items H15, H16, H17 and H18 in the first area 1311 based on date/time and popularity, and reflects updated property values to the content items H15, H16, H17 and H18 as time passes. The operations in the first area 1311 are substantially the same as those of the foregoing embodiments.

The second area 1312 is positioned on the right of the first area 1311, but this is merely an example and the comparative position of the second area 1312 is not limited to this example. In the second area 1312, content items H1 and H4, of which popularity is higher than a predetermined threshold, are displayed among the content items displayed in the first area 1311 at the previously point in time. As time passes, the content items displayed in the first area 1311 are replaced by new updated content items, but the content items H1 and H4, the popularity of which is relatively high, among the content items to be deleted from the first area 1311 are moved to the second area 1312 and maintained for a predetermined period of time. Thus, a user may selectively view the content items H1 and H4 having high popularity among the previously displayed content items that are not displayed in the first area 1311 at the current point in time.

The number and the displaying time of content items H1 and H4 displayed in the second area 1312 may be varied depending on design methods. The form of displaying the content items H1 and H4 in the second area 1312 may be the same as that in the first area 1311, or may be applied regardless of that in the first area 1311.

Meanwhile, the number of content items displayable in the screen by the display apparatus is based on the horizontal width of the content item. The foregoing embodiment showed only a case that the horizontal width of the content item has one value, but the horizontal width of the content item may be varied depending on specific conditions. Below, such an embodiment will be described.

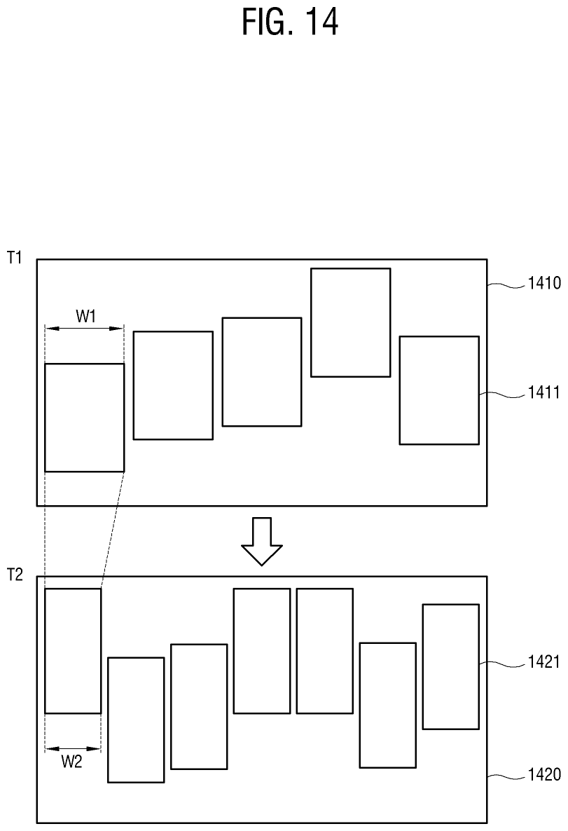

FIG. 14 illustrates that a display apparatus according to an embodiment of the disclosure changes widths of content items according to preset conditions.

As shown in FIG. 14, the display apparatus displays five content items 1411 each for example having a horizontal width W1 on a screen 1410 at a point in time T1. A method of displaying the content items 1411 on the screen 1410 is equivalent to those of the foregoing embodiments, and thus detailed descriptions thereof will be omitted.

To rearrange content items 1421 on the screen 1420 at a point in time T2 after the point in time T1, the display apparatus reduces the horizontal width of the content item 1421 from ‘W1’ to ‘W2’ based on whether a specific condition is given. Then, when it is identified that a state of a predetermined point in time after the point in time T2 does not meet the given condition, the display apparatus may return the horizontal width of the content item 1411 to ‘W1’ like the screen 1410 of the point in time T1.

There may be various conditions for reducing the horizontal width of the content item 1421 from ‘W1’ to ‘W2’ at the point in time T2.

As one example, the display apparatus may reduce the horizontal width of the content item based on the popularity distribution or popularity deviation of the content items for a predetermined period of time. When a first period of time and a second period of time corresponding to a current point in time are consecutively given, the content items corresponding to the first period of time are not displayed on the screen at the current point in time. However, when the content items of relatively low popularity are present for the second period of time but the content items of relatively high popularity are present for the first period of time, it may be more useful that the content items corresponding to the first period of time are also displayed on the screen in addition to the content items corresponding to the second period of time. To this end, the display apparatus reduces the horizontal widths of the content items and increases the number of content items displayable on one screen, thereby additionally displaying the content items corresponding to the previous period of time.

There may be various methods of identifying the popularity distribution of the content items corresponding to the first period of time. For example, when average popularity of the content items corresponding to the first period of time exceeds a predetermined threshold, it may be identified that the popularity distribution of the content items corresponding to the first period of time is high. Alternatively, when average popularity of the content items corresponding to the first period of time is higher than average popularity of the content items corresponding to the second period of time by a preset value, it may be identified that the popularity distribution of the content items corresponding to the first period of time is high.

Meanwhile, as another example, the display apparatus reduces the horizontal width of the content item in the screen when the number of content items of the content received per unit time exceeds a predetermined threshold value, but does not reduce the horizontal width of the content item in the screen when the number of content items does not exceeds a predetermined threshold value. In other words, when many news articles are received per unit time, the display apparatus reduces the horizontal width of the news article so that much more news articles can be displayed in one screen. Thus, when the display apparatus receives more news articles than usual, a user can be aware of the current state.

Below, a hardware configuration of a display apparatus according to an embodiment of the disclosure will be described.

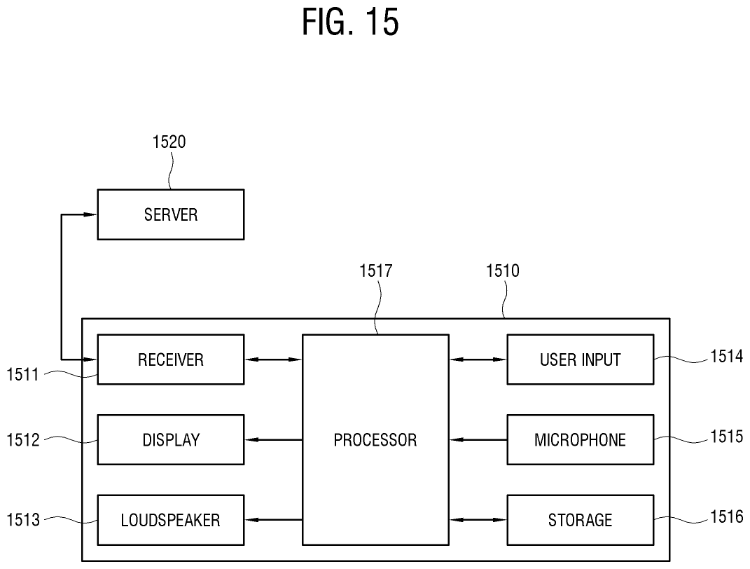

FIG. 15 is a block diagram of a display apparatus according to an embodiment of the disclosure.

As shown in FIG. 15, a display apparatus 1510 includes a receiver 1511 configured to receive a content signal from a server 1520, a display 1512 configured to display an image, a loudspeaker 1513 configured to output a sound, a user input 1514 configured to allow a user to perform input control, a microphone 1515 configured to receive a user utterance, a storage 1516 configured to store data, and a processor 1517 configured to perform a process for a content signal and a process for operations of the display apparatus.

The receiver 1511 refers to a communication circuit including a data input/output interface in which communication modules, ports, etc. corresponding to various communication protocols are combined. The receiver 1511 basically receives the content signal from the server 1520, but is configured to interactively transmit and receive a signal. According to this embodiment, the receiver 1511 is connected to the server 1520 through various kinds of wired or wireless communication protocols.

The display 1512 includes a display panel for displaying an image on a screen thereof. The display panel may have a liquid crystal type or the like structure for receiving light, or an organic light emitting diode (OLED) type or the like structure for emitting light in itself. The display 1512 may include an additional element in accordance with the types of the display panel. For example, when the display panel is the liquid crystal type, there are additionally provided a backlight unit for emitting light to a liquid crystal display (LCD) panel, a panel driving substrate for driving liquid crystal of the LCD panel, etc.

The loudspeaker 1513 outputs a sound based on an audio signal. The loudspeaker 1513 may include a unit loudspeaker corresponding to a piece of audio data for a certain audio channel, and may include a plurality of unit loudspeakers respectively corresponding to pieces of audio data for a plurality of audio channels.

The user input 1514 transmits a preset control command or information to the processor 1517 in response to a user's control or input. The user input 1514 may be achieved in various forms according to input methods of the information, and may be for example embodied by various user interface environments installed in the display apparatus 1510, such as a key provided on an outer side of the display apparatus 1510, a touch screen installed on the display 1512, a camera or sensor for capturing or sensing a user's gesture, etc. Further, the user input 1514 may include a remote controller physically separated from the display apparatus 1510.

The microphone 1515 generates an audio signal corresponding to a user utterance when receiving the user utterance, and transmits the audio signal to the processor 1517.

The storage 1516 is accessed by the processor 1517, and makes data undergo reading, recording, modifying, deleting, updating and the like operations under control of the processor 1517. The storage 1516 may include a flash memory, a hard disk drive, a solid state drive (SSD), and the like nonvolatile memory capable of retaining data regardless of whether the sink device 1510 is turned on or off; and a buffer, a random access memory (RAM) and the like to which data to be processed is loaded.

The processor 1517 applies a process to a content signal received in the receiver 1511 so that a content image can be displayed on the display 1512. The processor 1517 extracts image data from the content signal, decodes the image data and outputs the decoded image data to the display 1512. The processor 1517 includes a hardware processor achieved in a central processing unit (CPU), a chipset, a buffer, a circuit, etc. mounted on a printed circuit board, and may be achieved by a system on chip (SoC) in accordance with designs. The processor 1517 may include a demultiplexer, a decoder, a scaler, an audio digital signal processor (DSP), an amplifier, and the like modules corresponding to various processes, some of which may be materialized as the SoC. For example, the demultiplexer, the decoder, the scaler and the like modules related to video processing may be materialized as a video processing SoC, and the audio DSP may be materialized as a chipset separated from the SoC.

The processor 1517 according to this embodiment processes content from the server 1520 so that an image of a content screen including a plurality of content items can be displayed on the display 1512, and details in this regard are the same as described in the foregoing embodiments.

The methods according to the foregoing exemplary embodiments may be achieved in the form of a program command that can be implemented in various computers, and recorded in a computer readable medium. Such a computer readable medium may include a program command, a data file, a data structure or the like, or combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for realizing the exemplary embodiments. The program command recorded in this storage medium may be specially designed and configured according to the exemplary embodiments, or may be publicly known and available to those skilled in the art of computer software.

1. A display apparatus comprising:
a receiver configured to communicate with a server;
a display comprising a screen on which an image is displayable; and
a processor configured to:
identify property values about two or more properties with respect to a plurality of content items based on information received from the server,
control the display to display the content items to be arranged at positions corresponding to the property values along different directions on the screen based on the properties, and
rearranges the content items based on change in the property value as updated with information received from the server.

2. The display apparatus according to claim 1, wherein the processor is configured to identify values respectively corresponding to the properties on a plurality of axes about the two or more properties, and arrange the content items at positions on the screen based on the identified values.

3. The display apparatus according to claim 1, wherein the processor is configured to adjust a display state of the content item, based on a property value about another property other than the two or more properties.

4. The display apparatus according to claim 3, wherein the display state of the content item comprises at least one of emphasis, highlight, color, transparency, size, or chroma of the content item.

5. The display apparatus according to claim 1, wherein the processor is configured to adjust a display state of a certain area of the content item adjacent to an edge of the screen based on a truncated part of the content item over the edge of the screen.

6. The display apparatus according to claim 5, wherein the processor is configured to increase transparency of the area of the content item adjacent to the edge as getting closer to the edge.

7. The display apparatus according to claim 1, wherein the processor is configured to store the plurality of content items given with serial numbers in a cache, and rotate and display the plurality of content items on the screen in order of the serial number every predetermined period of time.

8. The display apparatus according to claim 1, further comprising a microphone configured to receive a user utterance,
wherein the processor is configured to recognize one or more words from the utterance received through the microphone, and automatically execute one content item including the recognized one or more words among the plurality of content items.

9. The display apparatus according to claim 8, wherein the processor is configured to compare and identify the plurality of words included in the utterance with the plurality of content items in sequence until the one content item is identified among the plurality of content items.

10. The display apparatus according to claim 1, wherein the processor is configured to receive the information comprising the content from the server every preset period of time.

11. The display apparatus according to claim 1, wherein the processor is configured to adjust at least one of a width or length of the content item displayed on the screen based on the number of content items received per unit time.

12. A method of controlling a display apparatus, comprising:
receiving information from a server;
identifying property values about two or more properties with respect to a plurality of content items based on the information, and displaying an image of the screen by arranging the content items at positions corresponding to the property values along different directions on the screen based on the properties; and
rearranging the content items on the screen based on change in the property value as updated with information received from the server.

13. The method according to claim 12, wherein the displaying the image of the screen comprises identifying values respectively corresponding to the properties on a plurality of axes about the two or more properties, and arranging the content items at positions on the screen based on the identified values.

14. The method according to claim 12, further comprising adjusting a display state of the content item, based on a property value about another property other than the two or more properties.

15. The method according to claim 12, further comprising adjusting a display state of a certain area of the content item adjacent to an edge of the screen based on a truncated part of the content item over the edge of the screen.
